(19) United States
(12) Patent Application Publication
(10) Pub. No.: US 2024/0086525 A1
(43) Pub. Date: Mar. 14, 2024

(54) SECURITY BREACH AUTO-CONTAINMENT AND AUTO-REMEDIATION IN A MULTI-TENANT CLOUD ENVIRONMENT FOR BUSINESS CONTINUITY

(71) Applicant: International Business Machines Corporation, Armonk, NY (US)

(72) Inventors: Arielle Tovah Orazio, WOOD-RIDGE, NJ (US); Lloyd Wellington Mascarenhas, White Plains, NY (US); Matthias Seul, Folsom, CA (US)

(21) Appl. No.: 17/931,297

(22) Filed: Sep. 12, 2022

(51) Int. Cl. G06F 21/55; G06F 21/53

(52) U.S. Cl. CPC G06F 21/554; G06F 21/53; G06F 2221/034

(57) ABSTRACT

One embodiment of the invention provides a method comprising identifying a tenant compromised by a security breach in a multi-tenant cloud environment including at least one virtual machine (VM), and storing at least one snapshot of the at least one VM. The method further comprises automatically performing containment of the security breach by mitigating the tenant compromised by the security breach. The method further comprises automatically performing remediation of at least one salvageable image in the environment by migrating one or more other tenants not yet compromised by the security breach in the environment to a sandbox, verifying the one or more other tenants are not compromised by the security breach by testing the one or more other tenants in the sandbox for a probationary period, and migrating the one or more other tenants to a new cloud container in production environment in response to the verifying.

### BACKGROUND

The field of embodiments of the invention generally relate to security breach detection and remediation.

A cloud service provider maintains a complex underlying infrastructure to manage complex cloud hardware and/or software components. The infrastructure provides many services such as, but not limited to, a security service, a computing service, a networking service, a storage service, a telemetry service, a resource management service, etc. Providing many services results in a high number of potential attack surfaces with regards to security. With such a high number of attack surfaces, it becomes hard to analyze security aspects of the infrastructure. Further, public multi-tenant cloud environments face multiple challenges with respect to compliance security and privacy, data separation or network isolation, misconfiguration, and logical security, authentication, and access control.

### SUMMARY

Embodiments of the invention generally relate to security breach detection and remediation, and more specifically, to security breach auto-containment and auto-remediation in a multi-tenant cloud environment.

One embodiment of the invention provides a method for security breach auto-containment and auto-remediation. The method comprises identifying a tenant compromised by a security breach in a multi-tenant cloud environment including at least one virtual machine (VM), and storing at least one snapshot of the at least one VM. The method further comprises automatically performing containment of the security breach by mitigating the tenant compromised by the security breach. The method further comprises automatically performing remediation of at least one salvageable image in the environment by migrating one or more other tenants not yet compromised by the security breach in the environment to a sandbox, verifying the one or more other tenants are not compromised by the security breach by testing the one or more other tenants in the sandbox for a probationary period, and migrating the one or more other tenants to a new cloud container in production environment in response to the verifying. Other embodiments include a system for security breach auto-containment and auto-remediation, and a computer program product for security breach auto-containment and auto-remediation. These features contribute to the advantage of auto-containment of ongoing security breaches and auto-remediation of salvageable images in a multi-tenant cloud environment, thereby avoiding data cross-contamination and ensuring business continuity.

One or more of the following features may be included.

In some embodiments, the mitigating comprises freezing or deleting the tenant compromised by the security breach. In some embodiments, the remediation comprises forensically analyzing the at least one snapshot of the at least one VM to determine whether there is data cross-contamination, data leakage, or data exposure.

In some embodiments, the remediation comprises creating a dummy container or virtual machine with fake data to protect confidentiality, privacy, and integrity of other tenants.

In some embodiments, the testing allows for ongoing determination as to whether each virtual machine corresponding to the one or more other tenants have active malware or malware traces, fragments, or remnants. Each virtual machine corresponding to the one or more other tenants is able to continue operations (to ensure business continuity) but is still monitored/observed in the sandbox under heightened scrutiny and tight security protocols for the probationary period, thereby enabling discovery of latent malware infection/attacks while reducing or minimizing disruptions to services/businesses. Unlike conventional technologies, this removes the need to isolate or throw away an entire system.

In some embodiments, the identifying comprises detecting suspicious behavior in the multi-tenant cloud environment. Unlike conventional technologies that primarily focus on network traffic parameters, network traffic parameters along with user and system behavior are monitored.

### BRIEF DESCRIPTION OF THE DRAWINGS

The subject matter which is regarded as embodiments of the invention are particularly pointed out and distinctly claimed in the claims at the conclusion of the specification. The foregoing and other objects, features, and advantages of embodiments of the invention are apparent from the following detailed description taken in conjunction with the accompanying drawings in which:

FIG. 1 depicts a computing environment according to an embodiment of the present invention;

FIG. 2 illustrates an example computing architecture for implementing security breach auto-containment and auto-remediation in a multi-tenant cloud environment, in accordance with an embodiment of the invention;

FIG. 3 illustrates an example security breach detection and remediation system in detail, in accordance with an embodiment of the invention;

FIG. 4 illustrates an example multi-tenant cloud environment, in accordance with an embodiment of the invention;

FIG. 5A illustrates an example auto-remediation process in response to an attack in the multi-tenant cloud environment, in accordance with an embodiment of the invention;

FIG. 5B illustrates a continuation of the auto-remediation process in FIG. 5A, in accordance with an embodiment of the invention; and

FIG. 6 is a flowchart for an example process for implementing security breach auto-containment and auto-remediation in a multi-tenant cloud environment.

The detailed description explains the preferred embodiments of the invention, together with advantages and features, by way of example with reference to the drawings.

### DETAILED DESCRIPTION

Embodiments of the invention generally relate to security breach detection and remediation, and more specifically, to security breach auto-containment and auto-remediation in a multi-tenant cloud environment. One embodiment of the invention provides a method comprising identifying a tenant compromised by a security breach in a multi-tenant cloud environment including at least one virtual machine (VM), and storing at least one snapshot of the at least one VM. The method further comprises automatically performing containment of the security breach by mitigating the tenant compromised by the security breach. The method further comprises automatically performing remediation of at least one salvageable image in the environment by migrating one or more other tenants not yet compromised by the security breach in the environment to a sandbox, verifying the one or more other tenants are not compromised by the security breach by testing the one or more other tenants in the sandbox for a probationary period, and migrating the one or more other tenants to a new cloud container in production environment in response to the verifying.

Another embodiment of the invention provides a system comprising at least one processor and a non-transitory processor-readable memory device storing instructions that when executed by the at least one processor causes the at least one processor to perform operations. The operations include identifying a tenant compromised by a security breach in a multi-tenant cloud environment including at least one VM, and storing at least one snapshot of the at least one VM. The operations further include automatically performing containment of the security breach by mitigating the tenant compromised by the security breach. The operations further include automatically performing remediation of at least one salvageable image in the environment by migrating one or more other tenants not yet compromised by the security breach in the environment to a sandbox, verifying the one or more other tenants are not compromised by the security breach by testing the one or more other tenants in the sandbox for a probationary period, and migrating the one or more other tenants to a new cloud container in production environment in response to the verifying.

One embodiment of the invention provides a computer program product comprising a computer readable storage medium having program instructions embodied therewith. The program instructions are executable by a processor to cause the processor to identify a tenant compromised by a security breach in a multi-tenant cloud environment including at least one VM, and store at least one snapshot of the at least one VM. The program instructions are executable by the processor to further cause the processor to automatically perform containment of the security breach by mitigating the tenant compromised by the security breach. The program instructions are executable by the processor to further cause the processor to automatically perform remediation of at least one salvageable image in the environment by migrating one or more other tenants not yet compromised by the security breach in the environment to a sandbox, verifying the one or more other tenants are not compromised by the security breach by testing the one or more other tenants in the sandbox for a probationary period, and migrating the one or more other tenants to a new cloud container in production environment in response to the verifying.

Public multi-tenant cloud environments face multiple challenges with respect to compliance security and privacy, data separation or network isolation, misconfiguration, and logical security, authentication, and access control. With respect to data separation or network traffic isolation, lack of network traffic isolation makes tenants susceptible to different forms of attack (e.g., a combination of lack of network bandwidth and network traffic isolation). For example, a malicious tenant may attack a resident tenant in the same data center or the same cloud service provider.

With respect to misconfiguration, a cloud service provider may provide custom configuration for different types of applications of different tenants. When there is a change in management made by a customer or a cloud service provider, there always runs a risk that something may have been misconfigured. Any misconfiguration may affect the barriers that separate the tenants from one another, resulting in data cross-contamination, data exposure, or data leakage.

Logical security, authentication, and access control will be different for each tenant depending upon the tenant's security policies. A tenant's security policies may be weak (e.g., weak encryption, missing two factor authentication, etc.).

One or more embodiments provide a framework that avoids data cross-contamination from the same cloud service provider providing services to multiple companies if a system administrator is using the same computer system/device. Unlike conventional technologies that primarily focus on network traffic parameters, the framework monitors trends in network traffic parameters along with user and system behavior. The framework provides auto-detection of security breaches as well as auto-remediation.

One or more embodiments provide a framework for auto-containment of ongoing security breaches and auto-remediation of salvageable images in a multi-tenant cloud environment, thereby ensuring business continuity. The framework provides a transparent way to freeze tenants for forensic analysis, move tenants to a secure location, and distinguish between production and probation sandbox production via auto-isolation. Probation sandbox production involves moving a virtual machine of the environment that is not already compromised by the breaches (i.e., not yet infected) to a container on a different cloud (or a different instance), where the virtual machine is able to continue operations (to ensure business continuity) but is still monitored/observed in a sandbox under heightened scrutiny and tight security protocols for a probationary period. Probation sandbox production allows for ongoing determination as to whether the virtual machine has active malware or malware traces, fragments, or remnants. Probation sandbox productions provides an in-between state where a virtual machine is allowed to run to ensure business continuity, but is proactively tested in a sandbox with additional monitoring and verification placed upon it to discover latent malware infection/attacks. Probation sandbox production reduces or minimizes disruptions to services/businesses, allowing certain parts of a system to remain functional while tested. Therefore, unlike conventional technologies, probation sandbox production removes the need to isolate or throw away an entire system.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

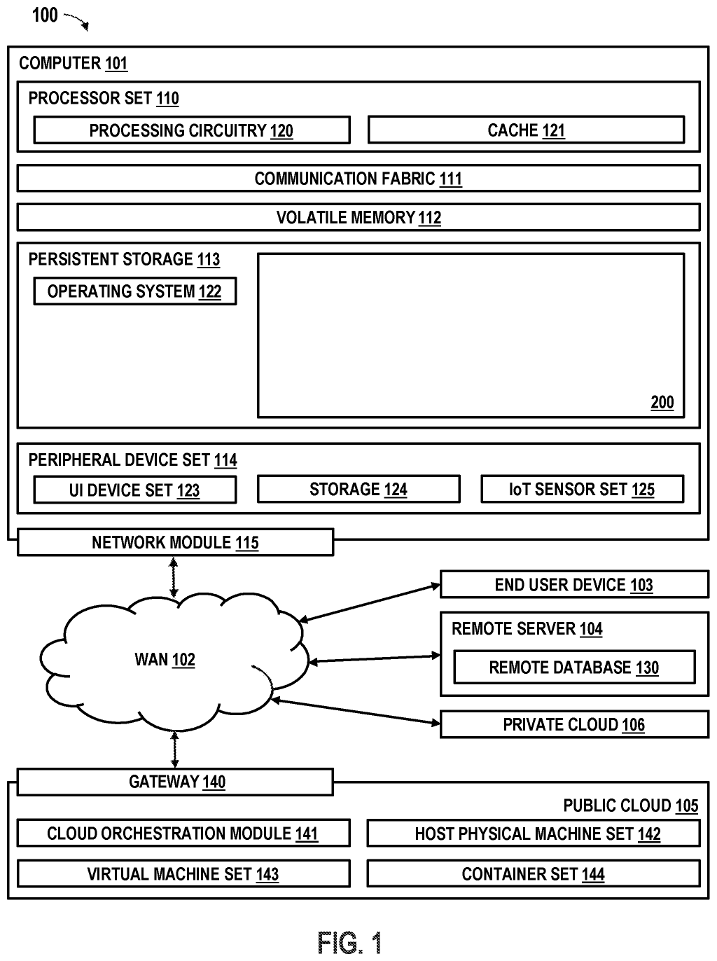

FIG. 1 depicts a computing environment 100 according to an embodiment of the present invention. Computing environment 100 contains an example of an environment for the execution of at least some of the computer code involved in performing the inventive methods, such as multi-layered graph modeling for security risk assessment 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

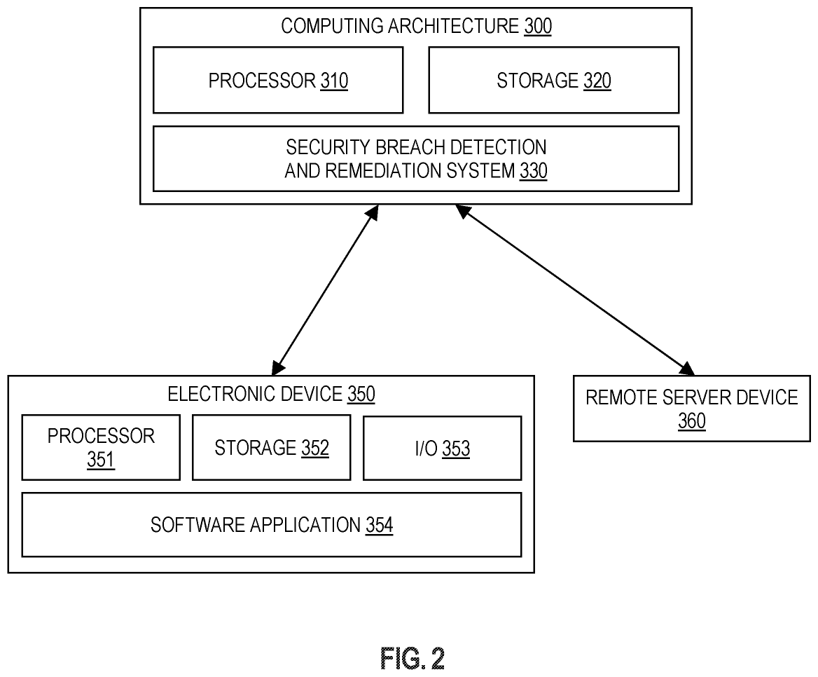

FIG. 2 illustrates an example computing architecture 300 for implementing security breach auto-containment and auto-remediation in a multi-tenant cloud environment, in accordance with an embodiment of the invention. In one embodiment, the computing architecture 300 is a centralized computing architecture. In another embodiment, the computing architecture 300 is a distributed computing architecture.

In one embodiment, the computing architecture 300 comprises computation resources such as, but not limited to, one or more processor units 310 and one or more storage units 320. One or more applications may execute/operate on the computing architecture 300 utilizing the computation resources of the computing architecture 300. In one embodiment, the applications on the computing architecture 300 include, but are not limited to, a security breach detection and remediation system 330 for a multi-tenant cloud environment. As described in detail later herein, the system 330 is configured to: (1) perform auto-containment involving automatically containing ongoing security breaches in the environment, and (2) perform auto-remediation involving automatically retaining salvageable images in the environment.

In one embodiment, the system 330 is configured to exchange data with one or more electronic devices 350 and/or one or more remote server devices 360 over a connection (e.g., a wireless connection such as a Wi-Fi connection or a cellular data connection, a wired connection, or a combination of the two).

In one embodiment, an electronic device 350 comprises one or more computation resources such as, but not limited to, one or more processor units 351 and one or more storage units 352. One or more applications may execute/operate on an electronic device 350 utilizing the one or more computation resources of the electronic device 350 such as, but not limited to, one or more software applications 354 loaded onto or downloaded to the electronic device 350. Examples of software applications 354 include, but are not limited to, system administration applications, etc.

Examples of an electronic device 350 include, but are not limited to, a desktop computer, a mobile electronic device (e.g., a tablet, a smart phone, a laptop, etc.), a wearable device (e.g., a smart watch, etc.), an Internet of Things (IoT) device, etc.

In one embodiment, an electronic device 350 comprises one or more input/output (I/O) units 353 integrated in or coupled to the electronic device 350, such as a keyboard, a keypad, a touch interface, a display screen, etc. A user (e.g., a cloud systems administrator, a tenant administrator) may utilize an I/O module 353 of an electronic device 350 to configure one or more user preferences, configure one or more parameters, provide input, etc.

In one embodiment, the system 330 may be accessed or utilized by one or more online services (e.g., system administration services) hosted on a remote server device 360 and/or one or more software applications 354 (e.g., system administration applications) operating on an electronic device 350. For example, in one embodiment, a software application 354 operating on an electronic device 350 can invoke the system 330 to perform security breach detection and remediation for a multi-tenant cloud environment.

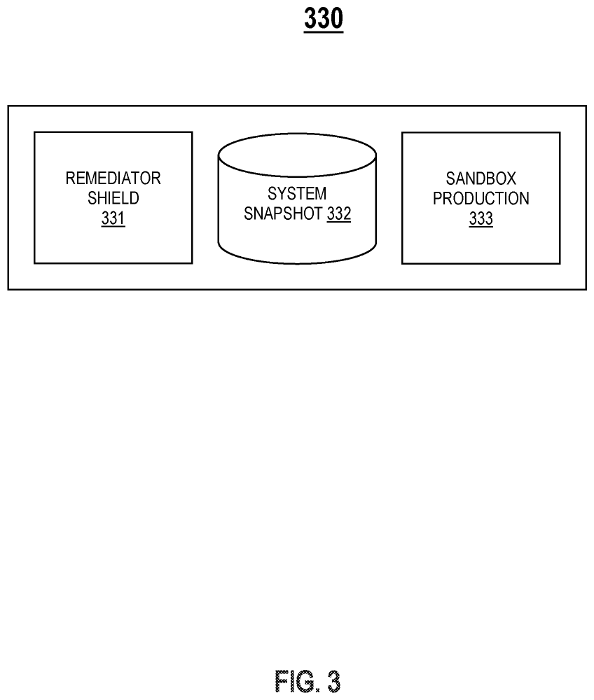

FIG. 3 illustrates an example security breach detection and remediation system 330 in detail, in accordance with an embodiment of the invention. In one embodiment, the system 330 comprises a remediator shield unit 331 configured to: (1) automatically detect ongoing security breaches in a multi-tenant cloud environment, (2) automatically contain the breaches (i.e., auto-containment), and (3) automatically retain salvageable images (i.e., auto-remediation).

In response to detecting an ongoing security breach in the multi-tenant cloud environment, the remediator shield unit 331 is configured to determine, for each virtual machine of each tenant of the multi-tenant cloud environment, whether the virtual machine is already compromised (i.e., already infected) by the breach or not yet compromised (i.e., not yet infected) by the breach. For each virtual machine determined as already compromised (“compromised virtual machine”), the remediator shield unit 331 mitigates the compromised virtual machine by freezing or destroying (i.e., deleting) the compromised virtual machine. For each virtual machine determined as not yet compromised (“non-compromised virtual machine”), the remediator shield unit 331 moves the non-compromised virtual machine to a container on a different cloud (or a different instance) for probation sandbox production.

In one embodiment, the remediator shield unit 331 is configured to capture a snapshot (i.e., image) of each virtual machine of the multi-tenant cloud environment before the virtual machine is mitigated or moved for probation sandbox production.

In one embodiment, the system 330 comprises a system snapshot database 332 configured to receive and maintain one or more snapshots (i.e., images) captured by the remediator shield unit 331. In one embodiment, the database 332 is deployed on one or more storage units 320 (FIG. 2) of the computing architecture 300 (FIG. 2). As described in detail later herein, in one embodiment, each snapshot maintained is forensically analyzed by the system 330 to determine whether there is data cross-contamination, data exposure, or data leakage.

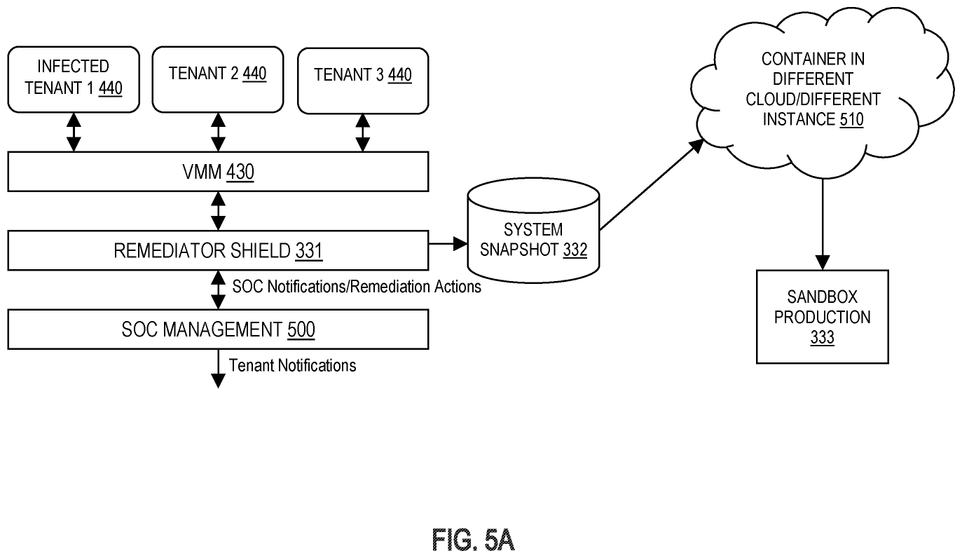

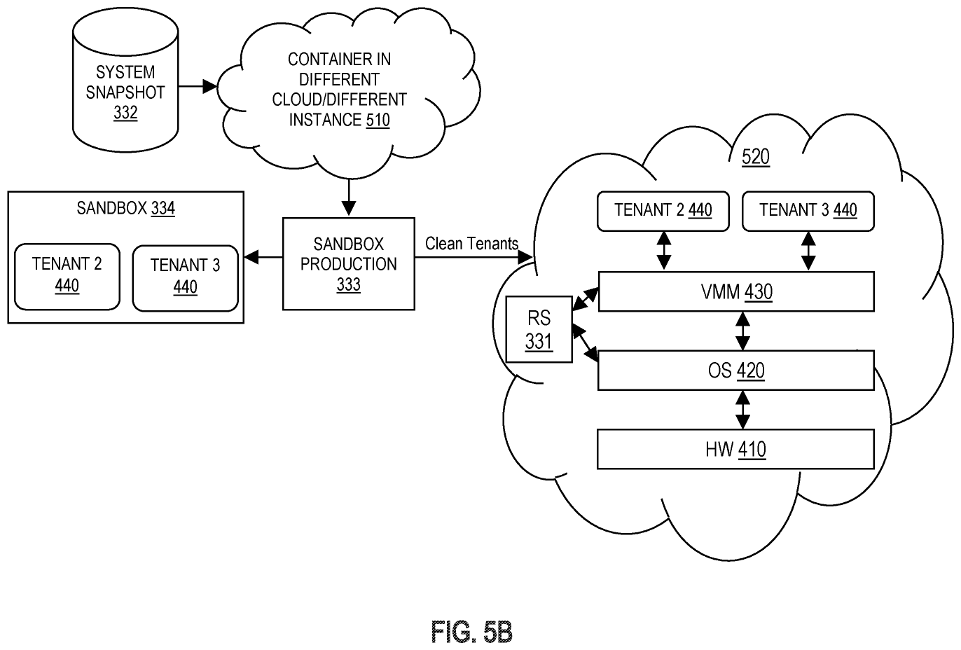

In one embodiment, the system 330 comprises a sandbox production unit 333 configured to implement probation sandbox production for each virtual machine moved to a container on a different cloud (or a different instance) via the remediator shield unit 331. Specifically, probation sandbox production involves a staged approach and rigorous testing/triage in a sandbox 334 (FIG. 5B) of each virtual machine moved to ensure: (1) there are no active malware (i.e., malware infections) present on the virtual machine, and (2) there are no malware traces, fragments, or remnants on the virtual machine. Each virtual machine moved is able to continue operations but is still monitored/observed via the sandbox production unit 333 for a probationary period. In one embodiment, as part of probation sandbox production, the sandbox production unit 333 forensically analyzes one or more snapshots maintained by the system snapshot database 332 to determine whether there is data cross-contamination, data exposure, or data leakage.

Probation sandbox production allows for ongoing determination as to whether a virtual machine moved has active malware or malware traces, fragments, or remnants. If there are no active malware and no malware traces, fragments, or remnants on a virtual machine moved after the probationary period has elapsed, the sandbox production unit 333 determines the virtual machine moved is clean (i.e., salvageable). The sandbox production unit 333 moves only clean virtual machines to a new cloud container in production environment. Salvageable images are automatically retained via probation sandbox production.

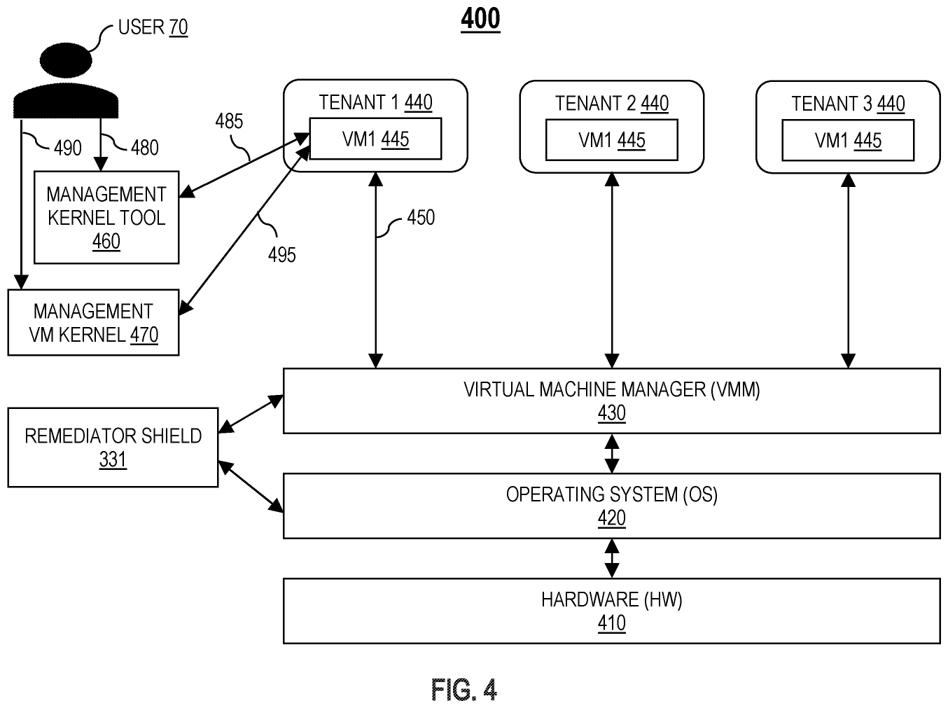

FIG. 4 illustrates an example multi-tenant cloud environment 400, in accordance with an embodiment of the invention. The environment 400 comprises hardware architecture 410 (e.g., subcomponents and buses), operating system (0S)/middleware/networking architecture 420, and applications/services architecture including a virtual machine manager (VMM) 430. The environment 400 further comprises one or more virtual machines 445 of one or more tenants 440 (e.g., VM 1 of Tenant 1, VM 2 of Tenant 2, VM 3 of Tenant 3, etc.). The VMM 430 is configured to exchange data with each virtual machine 445 over a corresponding connection 450.

The environment 400 provides a management kernel tool 460 and a management VM kernel 470 that a user 70 (e.g., a cloud systems administrator, a tenant administrator) may utilize to access and/or configure a virtual machine 445. The management kernel tool 460 is configured to exchange data with an electronic device (e.g., electronic device 350 in FIG. 2) utilized by the user 70 over a first connection 480, and is further configured to exchange data with the virtual machine 445 over a second connection 485. The management VM kernel 470 is configured to exchange data with the electronic device over a first connection 490, and is further configured to exchange data with the virtual machine over a second connection 495.

The environment 400 may be vulnerable to attacks. For example, if the user 70 is a compromised administrator or an attacker, the management kernel tool 460 and the management VM kernel 470 may be potential attack surfaces, and each connection 450, 480, 485, 490, and 495 may be potential attack paths.

In one embodiment, the remediator shield unit 331 is deployed in the environment 400 to provide auto-containment of ongoing security breaches and auto-remediation of salvageable images in the environment 400. In one embodiment, the remediator shield unit 331 provides monitoring to detect/recognize suspicious (i.e., unusual) behavior in the environment 400 such as, but not limited to, unusual memory usage and behavior, a corrupt image of a virtual machine 445, vulnerabilities including potential attack surfaces and potential attack paths, misconfiguration, overload, etc. In one embodiment, the monitoring is agent-based. In another embodiment, the monitoring is agentless. In another embodiment, the remediator shield unit 331 resides in a container (e.g., between physical and virtual machine systems of the environment 400).

Table 1 below provides examples of different behaviors in the environment 400 that the remediator shield unit 331 is configured to detect/recognize as suspicious.

TABLE 1
Behaviors Recognized as Suspicious

System powered on and not connected to the Internet for more than a
pre-determined amount of time (e.g., 3 mins)
System detected external memory
System connected to an IP range outside network parameter
System locked after a pre-defined number (e.g., 3) of failed attempts to
provide correct password
System unlocked and a cloud application launched without validation of
user credentials
Hard disk closed

FIG. 5A illustrates an example auto-remediation process in response to an attack in the multi-tenant cloud environment 400, in accordance with an embodiment of the invention. In one embodiment, the remediator shield unit 331 is configured to provide auto-containment of one or more ongoing security breaches by: (1) determining whether each virtual machine 445 (FIG. 4) of each tenant 440 is already infected by the breaches (i.e., compromised virtual machine), (2) capturing a snapshot (i.e., image) of each virtual machine 445, and (3) freeze or destroy (i.e., delete) each virtual machine 445 that is already infected. Each snapshot captured by the remediator shield unit 331 is maintained in the system snapshot database 332.

A tenant 440 is infected if a virtual machine 445 of the tenant 440 is infected by the breaches. For example, if the remediator shield unit 331 determines VM 1 (FIG. 4) of Tenant 1 is already infected (i.e., Infected Tenant 1) by the breaches, the remediator shield unit 331 freezes or destroys (i.e., deletes) VM 1.

In one embodiment, the remediator shield unit 331 is configured to provide auto-remediation of one or more of salvageable images in the environment 400 by: (1) moving each virtual machine 445 that is not yet infected by the breaches (i.e., non-compromised virtual machine) to a container 510 on a different cloud (or a different instance), and (2) invoking the sandbox production unit 333 to initiate probation sandbox production for each virtual machine 445 moved. For example, if the remediator shield unit 331 determines VM 2 (FIG. 4) of Tenant 2 and VM 3 (FIG. 4) of Tenant 3 are not yet infected by the breaches, the remediator shield unit 331 moves VM 2 and VM 3 for probation sandbox production.

In one embodiment, the remediator shield unit 331 is configured to exchange communications with a Security Operations Center (SOC) for the multi-tenant cloud environment 400. The SOC includes processes and technology for continuously monitoring security of the multi-tenant cloud environment 400. Specifically, the SOC collects, maintains, and regularly reviews all network activity and communications for the multi-tenant cloud environment 400, such as data feeds from its applications, firewalls, operating systems and endpoints. For example, in one embodiment, the SOC has a corresponding SOC management system 500 configured to receive from the remediator shield unit 331 one or more notifications indicative of any ongoing security breaches, any containment actions taken, and/or any remediation actions taken (e.g., freezing/destroying/deleting each compromised virtual machine, retaining salvageable images via probation sandbox production). In one embodiment, the SOC management system 500 is configured to receive from the remediator shield unit 331 one or more recommended remediation actions. The SOC management system 500 in turn provides one or more notifications to one or more tenants 440 of the environment 400.

FIG. 5B illustrates a continuation of the auto-remediation process in FIG. 5A, in accordance with an embodiment of the invention. In one embodiment, based on one or more snapshots maintained in the system snapshot database 332, the sandbox production unit 333 is configured to rigorously test/triage in a sandbox 334 each virtual machine 445 moved to ensure: (1) there are no active malware (i.e., malware infections) present on the virtual machine 445, and (2) there are no malware traces, fragments, or remnants on the virtual machine 445.

In one embodiment, the sandbox production unit 333 is configured to implement the following staged approach: (1) sync one or more non-dangerous files, (2) sync one or more prior versions of one or more dangerous files and/or a buffer, wherein the one or more prior versions are versions created pre-infection (i.e., before the breaches), and (3) sync one or more current versions of one or more dangerous files into a sandbox 334, wherein the one or more current versions may be infected (i.e., compromised) by the breaches.

In one embodiment, if the sandbox production unit 333 determines there are neither active malware (i.e., malware infections) nor malware traces, fragments, or remnants on a virtual machine 445 moved, the sandbox production unit 333 is configured to classify the virtual machine 445 as clean (i.e., salvageable). The sandbox production unit 333 is configured to move each virtual machine 445 classified as clean to a new cloud container 520 in production environment.

A tenant 440 is clean if all virtual machines 445 of the tenant 440 are classified as clean. For example, if the sandbox production unit 333 classifies VM 2 (FIG. 4) of Tenant 2 and VM 3 (FIG. 4) of Tenant 3 as clean, the sandbox production unit 333 moves Tenant 2 and Tenant 3 to the new cloud container 520.

In one embodiment, one or more components of the system 330 may be integrated into, implemented as part of, or work in combination with one or more systems (e.g., Security Information and Event Management (STEM) for monitoring traffic, user behavior, changes to known configurations, tenant memory behavior, changes to cloud API (e.g., insecure API), and/or changes in access control and security in the multi-tenant cloud environment 400. In one embodiment, one or more components of the system 330 may be integrated into, or implemented as part of, network parameter control for the multi-tenant cloud environment 400.

In one embodiment, the system 330 utilizes and keeps track of network bandwidth and connections in the multi-tenant cloud environment 400. For example, the system 330 utilizes and keeps track of time, hops, a location for an initial connection, port numbers, different protocols used (e.g., TCP, UDP), and/or changes in access control and security.

In one example application scenario, an attacker sets control of a network parameter to a system outside of a data center provided by a cloud service provider of the multi-tenant cloud environment 400. In response, tenants 440 of the environment 400 will self-destruct or self-corrupt hard disks, such that any data/metadata in the disks cannot be accessed. The remediator shield unit 331 will take containment and/or remediation actions such as, but not limited to, enforcing self-destruct/deep freeze in each tenant 440, creating a dummy container/virtual machine with fake data, etc.

In another example application scenario, the cloud service provider becomes compromised and an electronic device (e.g., a laptop) utilized by a cloud systems administrator is stolen (e.g., by an attacker) or confiscated (e.g., by a law enforcement agency), such that the electronic device is taken out of the network parameters. In response, tenants 440 of the environment 400 will deep freeze (i.e., disappear from the attacker). The remediator shield unit 331 will take containment and/or remediation actions such as, but not limited to, enforcing deep freeze in each tenant 440, capturing snapshots (i.e., images) for forensic analysis, etc.

In another example application scenario, a law enforcement agency investigating a particular tenant 440 of the multi-tenant cloud environment 400 provides warrants relating to the tenant 440. In response, a cloud systems administrator will initiate, via an electronic device, self-destruct or deep freeze of remaining tenants 440 of the environment 400 that are not involved in the investigation. The remediator shield unit 331 will take containment and/or remediation actions such as, but not limited to, enforcing self-destruct/deep freeze in each remaining tenant 440, capturing snapshots (i.e., images) for forensic analysis, etc. This will help in data isolation and prevent data of the remaining tenants 440 being inadvertently exposed (i.e., accidental data exposure). Snapshots captured may be stored in a separate container on the same cloud or in a container on a different cloud.

In another example application scenario, the cloud service provider allows administrators to work remote (e.g., from home), resulting in changes to network parameters. In response, the changes will require approval from tenants 440 of the multi-tenant cloud environment 400 (or the changes were already approved by the tenants 440). The remediator shield unit 331 will keep track of the changes and approvals.

In another example application scenario, an administrator is under duress (e.g., taken hostage). In response, the administrator will use a code or trigger creation of similar tenants with fake data and connections that an attacker is oblivious to. The remediator shield unit 331 will take containment and/or remediation actions such as, creating a dummy container/virtual machine with fake data, etc. This protects confidentiality, privacy, and integrity of other tenants 440 of the environment 400.

In another example application scenario, a malicious tenant 440 (e.g., Tenant 1) of the multi-tenant cloud environment 400 attacks another tenant 440 (e.g., Tenant 2) of the environment 400. Assuming the malicious tenant 440 is already compromised, the malicious tenant 440 makes changes to its own configuration, resulting in changes to the integrity of the operating system's kernel. Similar to a DDOS attack, the malicious tenant 440 consumes so much network bandwidth that the environment 400 is not able to handle the workload, impacting other tenants 440 of the environment 400. The remediator shield unit 331 will detect/recognize the suspicious behavior in the environment 400 (e.g., changes in the network bandwidth, overload, etc.) and communicate with the cloud service provider's security monitoring team (e.g., SOC) to alert the team of the suspicious behavior and provide recommended remediation actions. The remediator shield unit 331 will take containment and/or remediation actions such as, but not limited to, capturing snapshots (i.e., images) for forensic analysis, moving non-compromised tenants 440 to a container for probation sandbox production, etc.

In one embodiment, if there is no SIEM, the remediator shield unit 331 utilizes one or more techniques (e.g., AI) to detect/recognize suspicious behavior in the multi-tenant cloud environment 400. Table 2 below provides examples of different behaviors in the environment 400 that the remediator shield unit 331 is configured to detect/recognize as suspicious and to quantify (i.e., score). In one embodiment, self-destruct/deep freeze in each tenant 440 is auto-initiated if one or more pre-defined thresholds are met (e.g., malware attack confirmed, security breach or data leakage confirmed).

TABLE 2

| | | Risk score (i.e., | Pre-Defined |
|---|---|---|---|
| | | Persistence + | Threshold (Set |
| Suspicious Behavior & | Technique | Another Technique | to 80 or Higher to |
| Corresponding Score | Utilized | Utilized) | Initiate Deep Freeze) |
| External Remote Services 20 | Impact | Malicious | =90 |
| Replication Through Removable | Persistence | process | |
| Media 10 | Command and | injection in | |
| Endpoint Denial of Service 40 | control | memory 80 | |
| Data Encrypted for Impact 50 | Exfiltration | Scheduled | |
| Firmware corruption 30 | Execution | Task/Job 10 | |
| Exfiltration over different medium 40 | Lateral | Initial access 60 | |
| Scheduled transfer 30 | movement | Suspicious | |
| Malicious process injection in | Initial access | memory | |
| memory 80 | Defense evasion | behavior 70 | |
| Create modify system processes 40 | | Renaming files 40 | |
| Malicious files downloaded 40 | | Invoke | |
| Scheduled Task/Job 10 | | credentials 60 | |
| Kernel integrity failure 70 | | Multiple Failed | |
| Suspicious PowerShell script or auto | | logons 50 from | |
| script 60 | | the same user/IP | |
| System connected outside the | | Credential theft 80 | |
| predefined network paraments 60 | | Connection to | |
| Change is connection (port | | embargo | |
| numbers) 60 | | countries 90 | |
| Change is bandwidth 60 | | Disable | |
| Changes in VM configuration 70 | | privileges 90 | |
| Suspicious connections 50 | | Command and | |
| VM duplication or system restore 70 | | control | |
| | | connections 90 | |
| | | Token | |
| | | modification 60 | |
| | | Tokens | |
| | | impersonate 60 | |

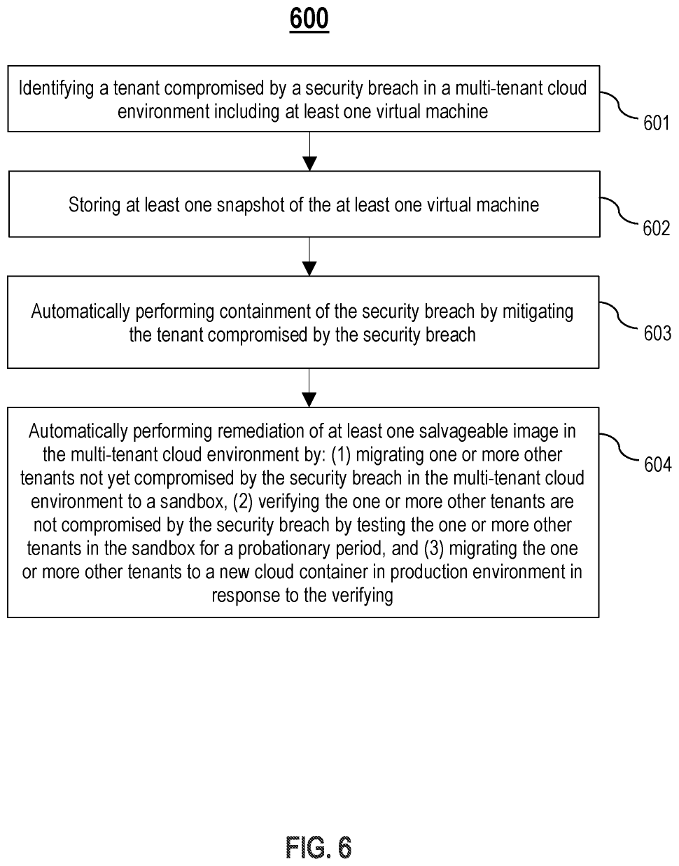

FIG. 6 is a flowchart for an example process 600 for implementing security breach auto-containment and auto-remediation in a multi-tenant cloud environment. Process block 601 includes identifying a tenant compromised by a security breach in a multi-tenant cloud environment including at least one virtual machine. Process block 602 includes storing at least one snapshot of the at least one virtual machine. Process block 603 includes automatically performing containment of the security breach by mitigating the tenant compromised by the security breach. Process block 604 includes including automatically performing remediation of at least one salvageable image in the multi-tenant cloud environment by migrating one or more other tenants not yet compromised by the security breach in the multi-tenant cloud environment to a sandbox, verifying the one or more other tenants are not compromised by the security breach by testing the one or more other tenants in the sandbox for a probationary period, and migrating the one or more other tenants to a new cloud container in production environment in response to the verifying.

In one embodiment, process blocks 601-604 are performed by one or more components of the system 330.

From the above description, it can be seen that embodiments of the invention provide a system, computer program product, and method for implementing the embodiments of the invention. Embodiments of the invention further provide a non-transitory computer-useable storage medium for implementing the embodiments of the invention. The non-transitory computer-useable storage medium has a computer-readable program, wherein the program upon being processed on a computer causes the computer to implement the steps of embodiments of the invention described herein. References in the claims to an element in the singular is not intended to mean “one and only” unless explicitly so stated, but rather “one or more.” All structural and functional equivalents to the elements of the above-described exemplary embodiment that are currently known or later come to be known to those of ordinary skill in the art are intended to be encompassed by the present claims. No claim element herein is to be construed under the provisions of 35 U.S.C. § 112(f), unless the element is expressly recited using the phrase “means for” or “step for.”

The terminology used herein is for the purpose of describing particular embodiments of the invention only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed.

The descriptions of the various embodiments of the invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for security breach auto-containment and auto-remediation, comprising:
identifying a tenant compromised by a security breach in a multi-tenant cloud environment including at least one virtual machine (VM);
storing at least one snapshot of the at least one VM;
automatically performing containment of the security breach by mitigating the tenant compromised by the security breach; and
automatically performing remediation of at least one salvageable image in the multi-tenant cloud environment by:
migrating one or more other tenants not yet compromised by the security breach in the multi-tenant cloud environment to a sandbox;
verifying the one or more other tenants are not compromised by the security breach by testing the one or more other tenants in the sandbox for a probationary period; and
migrating the one or more other tenants to a new cloud container in production environment in response to the verifying.

2. The method of claim 1, wherein the mitigating comprises freezing or deleting the tenant compromised by the security breach.

3. The method of claim 1, wherein the remediation further comprises:
forensically analyzing the at least one snapshot of the at least one VM to determine whether there is data cross-contamination, data leakage, or data exposure.

4. The method of claim 1, wherein the remediation further comprises:
creating a dummy container or virtual machine with fake data.

5. The method of claim 1, wherein the testing comprises:
determining there are no active malware present on each virtual machine corresponding to the one or more other tenants; and
determining there are no malware traces, fragments, or remnants on each virtual machine corresponding to the one or more other tenants.

6. The method of claim 1, wherein the identifying comprises:
detecting suspicious behavior in the multi-tenant cloud environment.

7. The method of claim 1, further comprising:
providing one or more notifications of the security breach to a security operations center for the multi-tenant cloud environment.

8. The method of claim 7, further comprising:
providing one or more recommended remediation actions to the security operations center.

9. A system for security breach auto-containment and auto-remediation, comprising:
at least one processor; and
a non-transitory processor-readable memory device storing instructions that when executed by the at least one processor causes the at least one processor to perform operations including:
identifying a tenant compromised by a security breach in a multi-tenant cloud environment including at least one virtual machine (VM);
storing at least one snapshot of the at least one VM;
automatically performing containment of the security breach by mitigating the tenant compromised by the security breach; and
automatically performing remediation of at least one salvageable image in the multi-tenant cloud environment by:
migrating one or more other tenants not yet compromised by the security breach in the multi-tenant cloud environment to a sandbox;
verifying the one or more other tenants are not compromised by the security breach by testing the one or more other tenants in the sandbox for a probationary period; and
migrating the one or more other tenants to a new cloud container in production environment in response to the verifying.

10. The system of claim 9, wherein the mitigating comprises freezing or deleting the tenant compromised by the security breach.

11. The system of claim 9, wherein the remediation further comprises:
forensically analyzing the at least one snapshot of the at least one VM to determine whether there is data cross-contamination, data leakage, or data exposure.

12. The system of claim 9, wherein the remediation further comprises:
creating a dummy container or virtual machine with fake data.

13. The system of claim 9, wherein the testing comprises:
determining there are no active malware present on each virtual machine corresponding to the one or more other tenants; and
determining there are no malware traces, fragments, or remnants on each virtual machine corresponding to the one or more other tenants.

14. The system of claim 9, wherein the identifying comprises:
detecting suspicious behavior in the multi-tenant cloud environment.

15. The system of claim 9, wherein the operations further comprise:
providing one or more notifications of the security breach to a security operations center for the multi-tenant cloud environment.

16. The system of claim 9, wherein the operations further comprise:
providing one or more recommended remediation actions to the security operations center.

17. A computer program product for security breach auto-containment and auto-remediation, the computer program product comprising a computer readable storage medium having program instructions embodied therewith, the program instructions executable by a processor to cause the processor to:
identify a tenant compromised by a security breach in a multi-tenant cloud environment including at least one virtual machine (VM);
store at least one snapshot of the at least one VM;
automatically perform containment of the security breach by mitigating the tenant compromised by the security breach; and
automatically perform remediation of at least one salvageable image in the multi-tenant cloud environment by:
migrating one or more other tenants not yet compromised by the security breach in the multi-tenant cloud environment to a sandbox;
verifying the one or more other tenants are not compromised by the security breach by testing the one or more other tenants in the sandbox for a probationary period; and
migrating the one or more other tenants to a new cloud container in production environment in response to the verifying.

18. The computer program product of claim 17, wherein the mitigating comprises freezing or deleting the tenant compromised by the security breach.

19. The computer program product of claim 17, wherein the remediation further comprises:
forensically analyzing the at least one snapshot of the at least one VM to determine whether there is data cross-contamination, data leakage, or data exposure.

20. The computer program product of claim 17, wherein the remediation further comprises:
creating a dummy container or virtual machine with fake data.
